(19) United States
(12) Patent Application Publication
(10) Pub. No.: US 2014/0281914 A1
(43) Pub. Date: Sep. 18, 2014

(54) INFORMATION PROCESSING SYSTEM, INFORMATION PROCESSING DEVICE, AND INFORMATION PROCESSING METHOD

(71) Applicants: Yoshihiko Sakawaki, Kanagawa (JP); Xiaofeng Han, Kanagawa (JP)

(72) Inventors: Yoshihiko Sakawaki, Kanagawa (JP); Xiaofeng Han, Kanagawa (JP)

(73) Assignee: RICOH COMPANY, LTD., Tokyo (JP)

(21) Appl. No.: 14/203,770

(22) Filed: Mar. 11, 2014

(30) Foreign Application Priority Data
Mar. 15, 2013 (JP) 2013-053905

(51) Int. Cl. G06F 17/22

(52) U.S. Cl. CPC G06F 17/2247
USPC 715/234

(57) ABSTRACT

An information processing system includes a device, and a computer configured to provide display data to the device. The information processing system includes a storage unit configured to store setting information; an update unit configured to update the setting information stored in the storage unit based on setting information included in the display data; and a display configured to display the display data, based on the setting information stored in the storage unit that is updated by the update unit.

### BACKGROUND OF THE INVENTION

1. Field of the Invention

The present invention relates to an information processing system, an information processing device, and an information processing method.

2. Description of the Related Art

Browser software may be installed in an image forming apparatus. Such browser software may display Hyper Text Markup Language (HTML) data on a display of the image forming apparatus as an operations screen. There are some types of browser software that can display a screen. Among such types of browser software, there are some types of browser software that can control a device by parsing an extended script for controlling the device (which is referred to as “extended script,” hereinafter). A method called “doScan” may be considered as an example of the extended script. Here, “doScan” is an extended script representing a run command to execute scanning. With browser software that can parse an extended script, the extended script can be utilized as a browser-based application programming interface (API) for customization (cf. Patent Document 1 (Japanese Unexamined Patent Publication No. 2006-352845), for example).

Patent Document 2 (Japanese Unexamined Patent Publication No. 2012-063813) discloses an image forming apparatus such that, when a destination to be accessed by a Web browser is switched, setting of the Web browser is automatically switched to setting for displaying a Web page of the destination.

### SUMMARY OF THE INVENTION

For a case of a device, such as an image forming apparatus, unlike a case of a general purpose computer (e.g., a personal computer (PC)), for each web page displayed on the device, some commonality may be required for operating the device. At the same time, in some cases, operability specific to a particular web page may be prioritized. It is desirable to allow coexistence of commonality among a plurality of display data items and individuality of each of the display data items.

According to an aspect of the present invention, there is provided an information processing system including a device, and a computer configured to provide display data to the device. The information processing system includes a storage unit configured to store setting information; an update unit configured to update the setting information stored in the storage unit based on setting information included in the display data; and a display configured to display the display data, based on the setting information stored in the storage unit that is updated by the update unit.

According to another aspect of the present invention, there is provided a device including a storage unit configured to store setting information; an update unit configured to update the setting information stored in the storage unit based on setting information included in display data to be displayed, wherein the display data is received through a network; and a display configured to display the display data based on the setting information stored in the storage unit, wherein the setting information stored in the storage unit is updated by the update unit.

According to another aspect of the present invention, there is provided an information processing method of an information processing system including a device, and a computer configured to provide display data to the device. The information processing method includes a step, by the information processing system, of updating setting information stored in a storage unit based on setting information included in the display data to be displayed; and a step, by the information processing system, of displaying the display data based on the setting information stored in the storage device, wherein the setting information stored in the storage device is updated by the step of updating.

An embodiment of the present invention may allow coexistence of commonality among a plurality of display data items and individuality of each of the display data items.

Other objects, features and advantages of the present invention will become more apparent from the following detailed description when read in conjunction with the accompanying drawings.

### BRIEF DESCRIPTION OF THE DRAWINGS

FIG. 1 is a diagram showing an example of a system configuration according to an embodiment of the present invention;

FIG. 2 is a diagram showing an example of a hardware configuration of an image forming apparatus according to the embodiment;

FIG. 3 is a diagram showing an example of a hardware configuration of a Web server according to the embodiment;

FIG. 4A is a diagram showing an example of a functional configuration of the image forming apparatus according to the embodiment;

FIG. 4B is a diagram showing an example of a functional configuration of the Web server according to the embodiment;

FIG. 5 is a sequence diagram illustrating an example of a procedure executed by the image forming apparatus and the Web server;

FIG. 6 is a diagram showing an example of a definition of a Web page including an extended definition;

FIG. 7 is a diagram showing an example of information stored in a setting information storage unit;

FIG. 8 is a diagram showing a display example of a screen that is based on a Web page according to the embodiment; and

FIG. 9 is a diagram showing a display example of a screen for a case where a value of an auto_resize attribute is false.

### DETAILED DESCRIPTION OF THE PREFERRED EMBODIMENTS

Hereinafter, an embodiment of the present invention is explained by referring to the accompanying drawings. FIG. 1 is a diagram showing an example of a system configuration according to the embodiment. As shown in FIG. 1, an image forming apparatus 10 and a Web server 20 are capable of communicating each other through a network such as a local area network (LAN) or the Internet.

The image forming apparatus 10 may be a multifunction peripheral having a single housing. The image forming apparatus 10 may have two or more functions amongst a printing function, a scanning function, a copying function, and a facsimile transmission and reception function, for example. Alternatively, the image forming apparatus 10 may have one function of the above-described functions. In the embodiment, the image forming apparatus 10 includes a Web browser. The Web browser may be a program for causing an operations panel 15 (which is described below) to display a Web page. Functions of the Web browser may be extended for the image forming apparatus 10. For example, the Web browser may parse a script (which is referred to as “extended script,” hereinafter) for controlling a hardware component that is specific to the image forming apparatus 10. The extended script may be for receiving a run command to execute scanning or printing, for example. The Web browser included in the image forming apparatus 10 is referred to as “device browser,” hereinafter.

The Web server 20 may execute a Web application for providing a service through a Web page. Here, a Web page may be screen information that is defined by a predetermined page description language, such as the HyperText Markup Language (HTML). Alternatively or additionally, a Web page may be data that defines and/or that describes a script representing a processing instruction that may be input in response to an operation on a screen that is displayed based on the screen information. A screen based on a Web page that is provided by the Web server 20 may be displayed on the operations panel 15 of the image forming apparatus 10.

A single Web server 20 may provide a Web page to two or more image processing apparatuses 10. Additionally, a plurality of Web servers 20 may provide Web pages to a single image processing apparatus 10. The Web server 20 may be a single computer. Alternatively, the Web server 20 may be a computer system including a plurality of computers.

FIG. 2 is a diagram showing an example of a hardware configuration of the image forming apparatus 10 according to the embodiment. As depicted in FIG. 2, the image forming apparatus 10 may include hardware components, such as a controller 11; a scanner 12; a printer 13; a modem 14; the operations panel 15; a network interface 16; and an SD card slot 17.

The controller 11 may include a CPU 111; a random access memory (RAM) 112; a read-only memory (ROM) 113; a hard disk drive (HDD) 114; and a non-volatile random access memory (NVRAM) 115; for example. The ROM 113 may store programs and various types of data to be utilized by programs. The RAM 112 can be utilized as a memory area for loading a program, and/or as a program working area of the loaded program. The CPU 111 may achieve various functions by executing a program that is loaded in the RAM 112. The HDD 114 may store programs and various types of data that may be utilized by programs. The NVRAM 115 may store various types of setting information.

The scanner 12 may be a hardware component for reading an image on an original document (i.e., an image reading unit). The printer 13 may be a hardware component for printing print data onto a paper sheet (i.e., a printing unit). The modem 14 may be a hardware component for establishing a connection to a telephone network. The modem 14 may be used for executing facsimile transmission and/or reception of image data. The operations panel 15 may be a hardware component that includes an input unit and a display, for example. The input unit is for receiving an input from a user. The input unit may be a button, for example. The display may be a liquid crystal panel, for example. The liquid crystal panel may have a function as a touch panel. In such a case, the liquid crystal panel may also have a function as an input unit. The network interface 16 may be a hardware component for connecting to a network, such as a LAN. The network may be a wired network and/or a wireless network. The SD card slot 17 may be used for reading a program stored in a SD card 80. In other words, the image forming apparatus 10 may execute not only a program stored in the ROM 113, but also a program stored in the SD card 80. The program stored in the SD card 80 may be loaded in the RAM 112, and the program may be executed by the image forming apparatus 10. Alternatively or additionally, another type of a storage medium (e.g., a CD-ROM or a Universal Serial Bus (USB) memory) may be utilized in a similar manner as the SD card 80. Namely, a type of an external storage medium that can be used by the image forming apparatus 100 is not limited to the SD card 80. For using another type of an external storage medium other than the SD card 80, another type of a hardware component that conforms to the corresponding type of the external storage medium may be utilized, instead of (or in addition to) the SD card slot 17.

FIG. 3 is a diagram showing an example of a hardware configuration of the Web server 20 according to the embodiment. As depicted in FIG. 2, the Web server 20 may include, for example, a media drive 200; an auxiliary storage device 202; a memory 203; a CPU 204; and an interface device 205, which are mutually connected through a bus.

A program to be executed by the Web server 20 may be installed by using a storage medium 201, such as a CD-ROM. When the storage medium 201 storing a program is attached to the media drive 200, the program may be installed in the auxiliary storage device 202 through the media drive 200. As described above, a program may be installed by using the storage medium 201. Alternatively or additionally, a program may be downloaded from another computer through a network. The auxiliary storage device 202 may store files and/or data as well as an installed program.

When a command to activate a program is input, the memory 203 may read out a program from the auxiliary storage device 202, and the memory 203 may store the program. The CPU 204 may execute a function of the Web server 20 in accordance with a program stored in the memory 203. The interface device 205 may be used as an interface for connecting the Web server 20 to a network.

FIG. 4A is a diagram showing an example of a functional configuration of the image forming apparatus 10 according to the embodiment. FIG. 4B is a diagram showing an example of a functional configuration of the Web server 20 according to the embodiment. As depicted in FIG. 4A, the image forming apparatus 10 may include a device browser 121; and a device controller 122. The device browser 121 and the device controller 122 may be achieved by corresponding processes that are executed by the CPU 111. Here, a program that is installed in the image forming apparatus 10 may cause the CPU 111 to execute the processes. Additionally, the image forming apparatus 10 may include a setting information storage unit 123. The setting information storage unit 123 may be achieved by the HDD 114. Alternatively, the setting information storage unit 123 may be achieved by a storage device that is connected to the image forming apparatus 10 through a network.

The device browser 121 may retrieve a Web page from the Web server 20, and the device browser 121 may cause the operations panel 15 to display a screen that is based on screen information included in the Web page. Additionally, the device browser 121 may cause the image forming apparatus 10 to execute a process that corresponds to a program described in a script language, such as Java (registered trademark) script included in a Web page. With respect to the script, the device browser 121 may parse not only standard methods (functions) and properties (attributes), but also extended and/or added methods and properties for the image forming apparatus 10. The standard methods and properties may be the methods and properties that are defined, for example, in a specification of Java (registered trademark) script.

As depicted in FIG. 4A, the device browser 121 may include a Web page retrieving unit 131; a parser 132; an extended specification parser 133; a rendering unit 134; a script parser 135; and a script execution unit 136, for example.

The Web page retrieving unit 131 may retrieve a Web page corresponding to specified identification information (i.e., a Uniform Resource Locator (URL)) from the Web server 20.

The parser 132 may be an HTML parser for parsing content that defines a Web page retrieved by the Web page retrieving unit 131.

With respect to a content describing a Web page, the extended specification parser 133 may parse a definition (which is referred to as “extended definition,” hereinafter) that is based on a specification extended for the device browser 121. The extended specification parser 133 may read out setting information concerning the manner of displaying a Web page, which is stored in the setting information storage unit 123. The extended specification parser 133 may apply values that are specified as the extended definition to the read setting information. In other words, the setting information stored in the setting information storage unit 123 may include predetermined values (i.e., default values) of the extended definition.

The rendering unit 134 may cause the operations panel 15 to display a screen (an operation screen) defined by screen information of a Web page, based on a parsing result (analysis result) by the parser 132. The rendering unit 134 may display a screen based on the setting information to which the values of the extended definition may be applied.

When a Web page includes a script, the script parser 135 may parse (analyze) the script. The script execution unit 136 may cause a process corresponding to a script to be executed. To be more specific, the script execution unit 136 may be a collection of objects (e.g., Java (registered trademark) script objects) that causes a process corresponding to a script to be executed. The script execution unit 136 may include not only standard script objects, but also script objects (which are referred to as “extended script objects,” hereinafter) that cause processes corresponding to extended methods and/or extended properties to be executed. The extended script objects may transmit a request for executing a process corresponding to a script to the device controller 122.

The device controller 122 may control hardware resources of the image forming apparatus 10.

As depicted in FIG. 4B, the Web server 20 may include a Web page providing unit 21. The Web page providing unit 21 may deliver a Web page corresponding to a request (HTTP request) transmitted from the image forming apparatus 10. Here, the device browser 121 causes the image forming apparatus 10 to transmit the request. The Web page providing unit 21 may be achieved by a process executed by the CPU 204. Here, a program (e.g., a Web application) installed in the Web server 20 causes the CPU 204 to execute the process.

A Web page may be dynamically created in response to a request. Alternatively or additionally, a Web page may be stored in advance in the Web server 20, or in a storage device that can be connected to the Web server 20 through a network.

Alternatively or additionally, the image forming apparatus 10 may include a Web page providing unit 21. In other words, a Web page may be obtained in the image forming apparatus 10.

Hereinafter, an example of a procedure executed by the image forming apparatus 10 and the Web server 20 is explained. FIG. 5 is a sequence diagram illustrating an example of a procedure executed by the image forming apparatus 10 and the Web server 20.

For example, in response to a predetermined input through the operations panel 15 by a user of the image forming apparatus 10, the Web page retrieving unit 131 of the device browser 121 transmits an HTTP request indicating a request for retrieving a predetermined Web page to the Web server (S101). The Web page providing unit 21 of the Web server 20 generates a requested Web page (S102). Here, it is assumed that the requested Web page includes an extended definition. Subsequently, the Web page providing unit 21 returns an HTTP response including the requested Web page to the device browser 121 (S103).

FIG. 6 is a diagram showing an example of a definition of a Web page including an extended definition. For convenience, FIG. 6 shows a simplified definition.

FIG. 6 shows a Web page w1. The Web page w1 includes “auto_resize” attribute, which is indicated as “at1.” Here, “auto_resize” attribute at1 is an example of the extended definition. The auto_resize attribute at1 is an attribute that indicates whether a drawing element and/or a screen is adjusted so that the drawing element and/or the screen that is to be displayed based on the Web page w1 conforms to the size of the liquid crystal panel of the operations panel 15. When the value of the auto_resize attribute at1 is “true,” such adjustment is to be executed. When the value of the auto_resize attribute at1 is “false,” such adjustment is not to be executed. A default value of the auto_resize attribute at1 is stored in the setting information storage unit 123.

When the HTTP response is received by the Web page retrieving unit 131, the parser 132 starts parsing the Web page included in the HTTP response. The extended specification parser 133 reads the setting information (i.e., default values of the extended definition) in the setting information storage unit 123. Then, the extended specification parser 133 loads the read setting information to the RAM 112 (S104).

FIG. 7 is a diagram showing an example of information stored in the setting information storage unit 123. As depicted in FIG. 7, the setting information storage unit 123 stores, for each attribute item, a value that is associated with the name of the attribute. Here, the attribute item is an extended definition that can be specified by a <meta> tag. Each of the values can be set by a user in advance through the operations panel 15, for example. Hereinafter, the setting information loaded to the RAM 112 is referred to as “work setting information.”

When the extended definition is detected by the parser 132, the extended specification parser 133 updates the work setting information with the content of the extended definition (i.e., the extended specification parser 133 overwrites the work setting information with the content of the extended definition). For example, for the case of the example depicted in FIGS. 6 and 7, the value of the auto_resize attribute in the work setting information is updated from “false” to “true.”

When the parser 132 detects drawing information, the rendering unit 134 displays a screen including a drawing element that is based on the drawing information (S106). At this time, the rendering unit 134 modifies the manner of displaying the screen, based on the work setting information that is updated based on the extended definition. According to the embodiment, the screen can be displayed while the screen can be adjusted to the liquid crystal panel of the operations screen 15.

FIG. 8 is a diagram showing a display example of a screen that is based on a Web page according to the embodiment. The screen 510 depicted in FIG. 8 is based on the Web page w1 shown in FIG. 6. The character string “SAMPLE” is displayed because the drawing element in the Web page w1 is the character string “SAMPLE” that is surrounded by the <text> tags. Due to the value of the auto_resize attribute being “true,” the character string “SAMPLE” is displayed on the screen while the size of the character string is adjusted.

When the definition of the <meta> tag is missing in the Web page w1, or when the definition of the auto_resize attribute at1 within the <meta> tag is missing, the value of the auto_resize attribute may be “false.” In this case, the screen that is displayed based on the Web page w1 may be the screen depicted in FIG. 9, for example.

FIG. 9 is a diagram showing a display example of the screen when the value of the auto_resize attribute is “false.” As depicted in FIG. 9, the size of the character string “SAMPLE” may not be adjusted for a screen 520. Consequently, the character string is displayed in such a manner that a new line is started in the middle of the character string.

In the above-described example, the auto_resize attribute is explained as the example of the extended definition. However, the extended definition is not limited to the above-described example. The extended definition may include another attribute. The extended definition may include, for example, an attribute for switching between display or non-display of a scroll bar; an attribute for specifying brightness of a backlight of the liquid crystal panel; an attribute for specifying enabling or disabling of a flick operation (i.e., an operation of sliding a finger contacting a screen); and/or an attribute for specifying whether or not to output a beep sound or the like, in response to an operation with respect to a drawing element that is to be operated, such as a button.

In the above explanation, the extended definition may be defined by the attribute of the <meta> tag. However, an extended definition is not limited to this example. For example, an extended definition may be defined by a plurality of individual tags. Additionally or alternatively, an extended definition may be defined by a script.

As described above, according to the embodiment, a manner of displaying a Web page can be determined based on setting information stored in the setting information storage unit 123. Additionally, a portion or all the setting information may be modified based on an extended definition included in the Web page. Here, the setting information stored in the setting information storage unit 123 may be the information that can be commonly applied to a plurality of Web pages. The extended definition included in the Web page may be information that is effective only for the Web page. Consequently, the embodiment of the present invention may allow coexistence of commonality among a plurality Web pages and individuality of each of the plurality of Web pages.

In the above explanation, the Web server 20 is an example of a computer that provides display data to a device. The image forming apparatus 10 is an example of the device that receives the display data from the computer. The Web server 20 and the image forming apparatus 10 are an example of an information processing system. The setting information storage unit 123 is an example of a storage unit configured to store setting information. The extended definition in the Web page is an example of setting information included in display data. The extended specification parser 133 is an example of an update unit configured to update the setting information stored in the storage unit based on the setting information included in the display data. The rendering unit 134 is an example of a display configured to update the setting information stored in the storage unit based on setting information included in the display data. The auto_resize attribute is an example of an item of the setting information stored in the storage unit.

Hereinabove, the information processing system, the information processing device, and the information processing method are explained by the embodiment. However, the present invention is not limited to the specifically disclosed embodiment, and variations and modifications may be made without departing from the scope of the present invention.

In the above explanation, the Web page is used as the example of the display data. However, display data of the embodiment is not limited to this example. For example, instead of the Web page, display data whose format is different from that of the Web page and that can describe an instruction, similar to the script in the Web page, may be used.

A device to which the embodiment of the present invention can be applied is not limited to an image forming apparatus. For example, the embodiment of the present invention may be applied to a projector, a device for a video conference, a digital camera, and the like. Specific examples of numerical values are used in order to facilitate understanding of the invention. However, these numerical values are simply illustrative, and any other appropriate values may be used, except as indicated otherwise. The separations of the sections of the specification are not essential to the present invention. Depending on necessity, subject matter described in two or more sections may be combined and used, and subject matter described in a section may be applied to subject matter described in another section (provided that they do not contradict). A boundary of a functional unit or a processing unit in a functional block may not correspond to a boundary of a physical component. An operation by a plurality of functional units may be physically executed by a single component. Alternatively, an operation by a single functional unit may be physically executed by a plurality of components. For the convenience of explanation, the devices according to the embodiment of the present invention are explained by using the functional block diagrams. However, these devices may be implemented in hardware, software, or combinations thereof. The software may be prepared in any appropriate storage medium, such as a random access memory (RAM), a flash memory, a read-only memory (ROM), an EPROM, an EEPROM, a register, a hard disk drive (HDD), a removable disk, a CD-ROM, a database, a server, or the like.

The present application is based on and claims the benefit of priority of Japanese priority application No. 2013-053905 filed on Mar. 15, 2013, the entire contents of which are hereby incorporated herein by reference.

What is claimed is:

1. An information processing system including a device, and a computer configured to provide display data to the device, the information processing system comprising:
a storage unit configured to store setting information;
an update unit configured to update the setting information stored in the storage unit based on setting information included in the display data; and
a display configured to display the display data, based on the setting information stored in the storage unit that is updated by the update unit.

2. The information processing system according to claim 1,
wherein the setting information included in the display data includes a value with respect to an item of the setting information stored in the storage unit.

3. The information processing system according to claim 1,
wherein the setting information stored in the storage unit is common for a plurality of types of display data, and
wherein the setting information included in the display data is effective for the display data.

4. A device comprising:
a storage unit configured to store setting information;
an update unit configured to update the setting information stored in the storage unit based on setting information included in display data to be displayed, wherein the display data is received through a network; and
a display configured to display the display data based on the setting information stored in the storage unit, wherein the setting information stored in the storage unit is updated by the update unit.

5. The device according to claim 4,
wherein the setting information included in the display data includes a value with respect to an item of the setting information stored in the storage unit.

6. The device according to claim 4,
wherein the setting information stored in the storage unit is common for a plurality of types of display data, and
wherein the setting information included in the display data is effective for the display data.

7. An information processing method of an information processing system including a device, and a computer configured to provide display data to the device, the information processing method comprising:
a step, by the information processing system, of updating setting information stored in a storage unit based on setting information included in the display data to be displayed; and
a step, by the information processing system, of displaying the display data based on the setting information stored in the storage device, wherein the setting information stored in the storage device is updated by the step of updating.

8. The information processing method according to claim 7,
wherein the setting information included in the display data includes a value with respect to an item of the setting information stored in the storage unit.

9. The information processing method according to claim 7,
wherein the setting information stored in the storage unit is common for a plurality of types of display data, and
wherein the setting information included in the display data is effective for the display data.
